(19) United States
(12) Patent Application Publication
(10) Pub. No.: US 2021/0066896 A1
(43) Pub. Date: Mar. 4, 2021

(54) CONTAINER ARRANGEMENT FOR A MOBILE POWER TRANSFORMER UNIT

(71) Applicant: SIEMENS AKTIENGESELLSCHAFT, MUENCHEN (DE)

(72) Inventor: CHRISTIAN ETTL, WEIZ (AT)

(21) Appl. No.: 16/962,378

(22) PCT Filed: Dec. 18, 2018
(86) PCT No.: PCT/EP2018/085542

§ 371 Date: Jul. 15, 2020

(30) Foreign Application Priority Data
Jan. 15, 2018 (DE) 10 2018 200 586.9

(51) Int. Cl. H02B 1/52; H02G 11/02; H01F 27/28; H01F 27/24; B60P 3/035

(52) U.S. Cl. CPC H02B 1/52; H02G 11/02; B60P 3/035; H01F 27/24; H01F 27/2823

(57) ABSTRACT

A container arrangement for a transportable power transformer unit includes at least one container in which a first cable drum is situated. A first high-voltage cable having a first length and being configured for an operating voltage A, is wound on the first cable drum. In order to further shorten the commissioning of the power transformer unit, at least one further cable reel is disposed in the container. A further high-voltage cable having a different length is wound on the at least one further cable reel. Each further high-voltage cable is configured for the operating voltage A.

The invention relates to a container arrangement for a transportable power transformer unit having at least one container in which a first cable drum is arranged, on which a first high-voltage cable with a first length is wound, wherein the high-voltage cable is designed for an operating voltage A.

Such a container arrangement is already known from WO 2017/186716 A1. The container arrangement described therein serves to receive components for commissioning an arrangement of power transformers so that they can be assembled quickly on site. The container arrangement comprises containers in which cables, cable drums, cable pay-off devices, plug-in bushings, test and adapter plugs, tools and connecting lines for the cooling systems, control boxes, surge arresters and other components of the transformers which are required for the commissioning procedure are arranged.

Transformers for converting a high voltage into a low voltage, or vice versa, are used in electrical supply networks carrying an alternating voltage. In particular, large power transformers in this case can reach the size of an apartment building. In this case, the transformers are designed according to respective customer requirements, which means that, as a rule, they are produced as individual tailor-made structures. However, in the event of a fault, such transformers represent a critical component for the reliability of the network supply since failure of the transformer results in an interruption of the energy supply downstream. To enable the faulty transformer to be replaced, a replacement transformer has to be devised in an involved process and produced according to the requirements. This can lead to delay times of up to a year and more. Owing to its substantial weight and its size, the transportation of the replacement transformer is moreover time-consuming and can take several weeks, depending on the weather conditions. Further delays occur on site owing to the lengthy commissioning period.

WO 2017/186748 discloses a power transformer unit, which can be transported quickly and commissioned on site within a very short time. The power transformer unit has a plurality of single-phase transformers, for example three single-phase transformers, which can be flexibly adapted to the respective requirements. Therefore, each single-phase transformer can be designed, for example, for a particular input voltage and for a particular output voltage. A flexibly assemblable open-air terminal, which is connected to the transformer via a cable connection, enables flexible selection of the assembly site for the single-phase transformers.

For flexible set-up and assembly of the power transformer unit, auxiliary components are required which likewise have to be transported quickly to the assembly site with the single-phase transformers in order to enable quick and ordered access to the components required in each case.

The object of the invention is to provide a container arrangement of the type mentioned at the outset, with which the time for commissioning a transportable power transformer unit can be reduced even further.

The invention achieves this object in that at least one further cable drum, on which a further high-voltage cable with a further length is wound, is arranged on the container, wherein each further high-voltage cable is likewise designed for the operating voltage A.

According to the invention, a container arrangement is provided, which has at least one container, in which at least two cable reels are provided, wherein each cable reel is equipped with a cable which is designed for the same operating voltage, in this case A. The cables have different lengths. According to the invention, it is therefore possible to quickly find the cable which has the correct length for the respective installation site in a container which has, for example, a sign marked “operating voltage A”. In this context, it is, for example, advantageous that a plurality of containers with different operating voltages, for example operating voltage A, B or C, are provided, which are identical in terms of their construction and differ only with regard to the respective operating voltage for which the respective cables are designed. For example, if an output voltage of 138 kV is required, it is possible, within the context of the invention, to find the correct cable in the said container with the operating voltage 138 kV. If only a short cable is needed, it is possible to quickly access the correct cable drum, for example with the aid of a forklift, and transport this to the desired site in each case. According to the invention, quicker and, in particular more reliable, construction of the transportable power transformer unit on site is therefore enabled.

Each container is expediently designed in the form of a box and extends in a longitudinal direction, wherein the cable drums are arranged successively in the longitudinal direction. According to this further development of the invention, the internal volume of the container can be utilized particularly effectively. The cable drums generally have an inner cylindrical rotating cylinder, beyond which lateral delimiting tongues project on both sides so that the cable is wound onto the drum by rotating the drum in one direction of rotation, wherein the cable remains within the lateral delimitations of the cable drum. In this case, the axis of rotation of the cable drum when this is arranged in the container is aligned parallel to the longitudinal direction in which the container extends.

According to a preferred configuration of the invention, each container has two opposing end faces in the longitudinal direction and two side walls which extend parallel to one another in the longitudinal direction and are connected to the end faces at both sides, wherein one of the side walls has a side door or is formed as a side door, which is dimensioned so that access is simultaneously granted to all cable drums and these can be carried in and out of the container through the side door. According to this advantageous further development, the container, which is again designed in the form of a box, has at least one side door. The side door enables access to all cable drums simultaneously. Each cable drum can therefore be easily removed from the container in order to commission the transportable power transformer arrangement even more quickly on site. According to this further development, the container can therefore be opened and the choice can then quickly be made as to which cable drum is best suited to meet the requirements relating to the power transformer arrangement.

A holding frame is expediently provided in the container, which holding frame is designed to receive a plurality of cable drums which are arranged successively in the longitudinal direction. According to this advantageous configuration of the invention, at least one container has a so-called holding frame which serves to receive a plurality of cable drums and to store them in a stable manner. Cables are wound onto the cable drums of this container and serve to connect auxiliary components, but also to connect electrical components which are arranged on different single-phase transformers of the power transformer unit. Owing to the lower voltages for which these supply cables are designed, the cable drums can be dimensioned to be correspondingly smaller so that a plurality of cable drums can fit successively in a container. To also provide a structured order here, a holding frame is provided within the context of this further development of the invention. The holding frame has successively arranged holding frame portions, which are not connected to other holding frame portions. The individual holding frame portions can therefore be removed individually from the container.

A first and a second row of successively arranged cable drums are expediently provided in the holding frame, wherein the second row is arranged above the first row. According to this advantageous further development, the space within the respective container can be used even more effectively by the cable drums.

According to a further advantageous further development, the container is a 20 ft, a 40 ft or a so-called high-cube container. According to this variant of the invention, the dimensioning or, in other words the size, of the container corresponds to a standard size which, as such, is known to the person skilled in the art so that it is possible to dispense with more specific explanation here.

A plurality of plug-in bushings are expediently arranged in at least one container, wherein the bushings are designed for different operating voltages. In a deviation from this, it is, however, also possible within the context of the invention to arrange a bushing which is equipped for an operating voltage A in the container in which the cables of the cable drums arranged therein are likewise designed for an operating voltage A. If the power transformer units are designed for an input voltage A, for example, it is only necessary to open the container which is labeled “operating voltage A”, wherein the high voltage bushing and the cable drums with the correct cable length are subsequently fetched from the container.

A protection and control device is advantageously arranged in at least one container.

Further advantages are realized if the container is placed on a trailer which is fitted with wheels. The container arrangement can therefore be transported quickly and conveniently with the aid of a truck.

Further expedient configurations and advantages of the invention are the subject matter of the following description of exemplary embodiments of the invention with reference to the figures of the drawing, in which the same reference signs refer to similarly acting components and which show:

FIG. 1 an exemplary embodiment of a container of a container arrangement according to the invention,

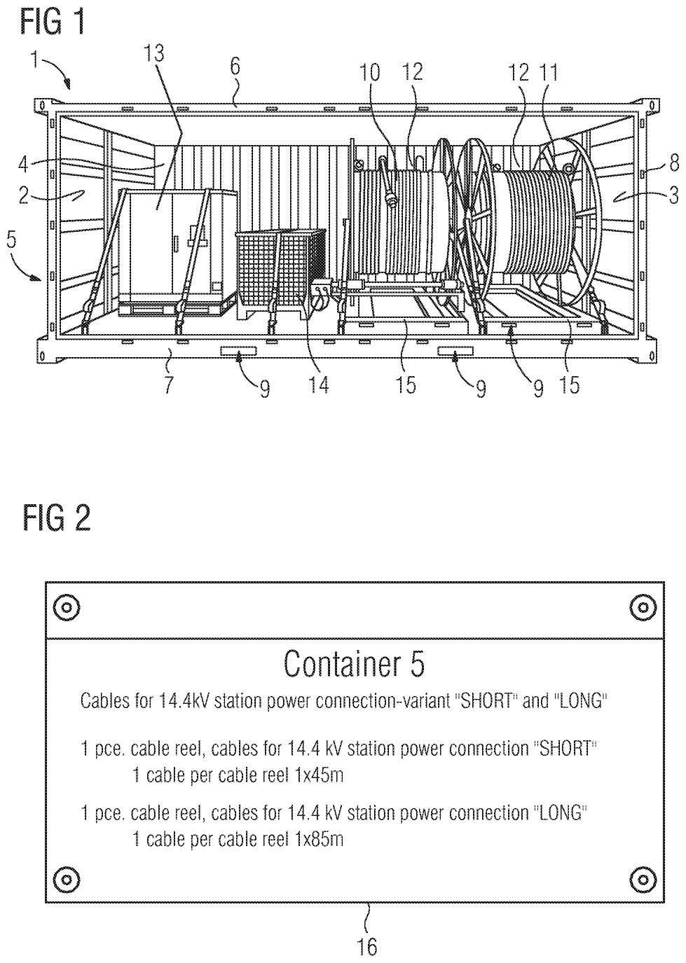

FIG. 2 a label of the container according to FIG. 1,

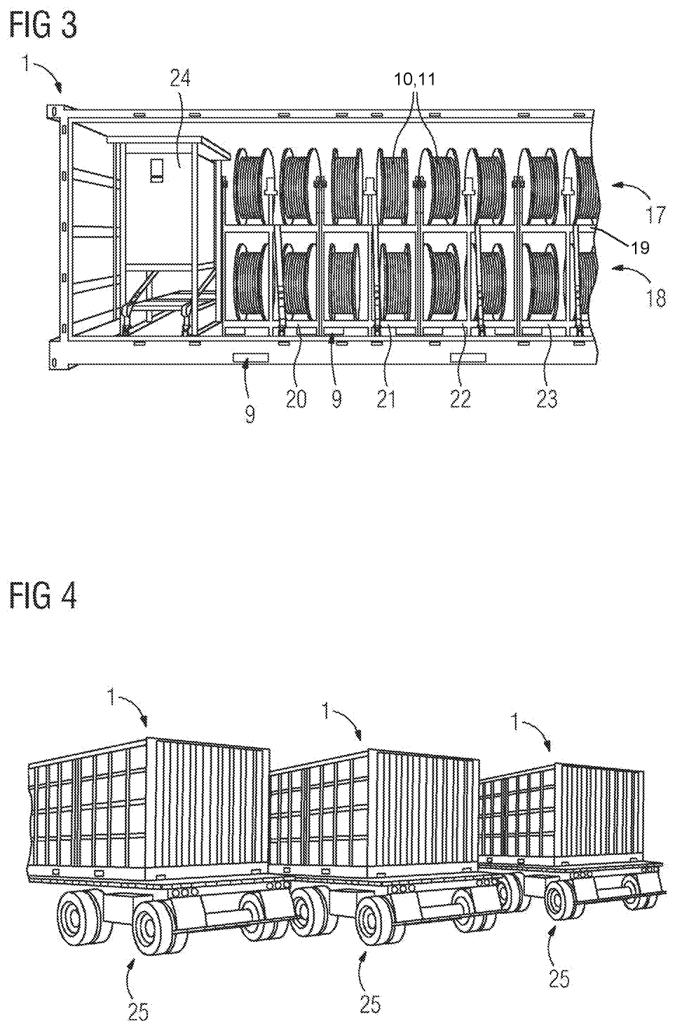

FIG. 3 a further exemplary embodiment of a container of a container arrangement according to the invention, and

FIG. 4 containers of an exemplary embodiment of a container arrangement according to the invention, which are placed on trailers.

FIG. 1 shows an exemplary embodiment of a container 1 of a container arrangement according to the invention, wherein the container 1 is designed in the form of a box. In this case, the container 1 extends in a longitudinal direction between a first end face 2 and a second end face 3. A side wall 4 extends between the end faces 2 and 3 in the said longitudinal direction, wherein a front side wall extending parallel thereto is not visible since it serves as a side door 5 which is open in FIG. 1, so that access to the interior of the container 1 is enabled.

An upper lid 6 and a lower base 7 furthermore extend between the end faces 2 and 3.

To hang the side door 5, hook connections 8 are visible, which are formed on the respective outer edge of the end faces 2 and 3 and on the edges of the lid 6 and also on the edge of the base 7. Recesses 9 in the base 7 are furthermore visible, into which the forks of a forklift can be inserted to lift the container as a whole.

Two cable drums 10 and 11 are arranged successively in the container 1. A cable 12, which is designed for an operating voltage of 52 kV (????), is wound on each cable drum 10, 11. In this case, the cable 12 of the cable drum 11 is longer than the cable 12 of the cable drum 10. An equipment cabinet 13 in which expedient sensors are arranged is also visible in the interior of the container 1. Auxiliary components such as drives, pumps and supply lines are furthermore stored in a holding basket 14.

The cable drums 10 and 11 are securely fastened on a carrying pallet 15 via expedient fastening means such as chains or holding belts, wherein each carrying pallet 15 again has recesses 9 so that the forks of a forklift can be inserted therein and the cable drums can be conveniently lifted out of the container 1.

FIG. 2 shows an exemplary embodiment of a container label 16 for a container 1 according to FIG. 1. The container label 16 reveals that the cables which are arranged within the container 1 are designed for an operating voltage of 14.4 kV, wherein a long and a short cable 12 are arranged in the container 1.

FIG. 3 shows a further exemplary embodiment of a container 1 of the container arrangement according to the invention, wherein, in terms of its construction, the container 1 is the same as the container shown in FIG. 1. In contrast to the exemplary embodiment shown in FIG. 1, however, not only two cable drums, but a whole number of cable drums 16, are provided within the container 1, which are each arranged successively in an upper row 17 and a lower row 18. A holding frame 19 serves to hold the cable drums 16 of the respective row 17 and 18, wherein the holding frame 19 comprises holding frame portions 20, 21, 22 and 23, which again each have recesses 9 for the forks of a forklift to reach therein. The holding frame portions 20, 21, 22 and 23 are not connected to one another, so that they can be conveyed individually out of and into the container 1. This facilitates the use of cables held by these portions, which can again have different lengths. Each holding frame portion 20, 21, 22, 23 can be associated with a particular cable length, so that all cables of this holding frame portion 20, 21, 22, 23 have the same cable length. A protection and monitoring device 24 for a transformer arrangement is furthermore visible in the container 1.

FIG. 4 shows three containers 1, which are each placed on a trailer 25 of a vehicle. In this case, the container 1 is in its transporting position in which all doors and, in particular, the side doors 5 are closed. The containers 1 can thus be transported quickly to the respective installation site.

1-10. (canceled)

11. A container arrangement for a transportable power transformer unit, the container arrangement comprising:
at least one container;
a first cable drum disposed in said at least one container, and a first high-voltage cable wound on said first cable drum with a first length, said first high-voltage cable being rated for an operating voltage A; and
at least one further cable drum disposed in said at least one container, and at least one further high-voltage cable wound on said at least one further cable drum with a length different than said first length, said at least one further high-voltage cable being rated for the operating voltage A.

12. The container arrangement according to claim 11, wherein said at least one container is constructed as a box extending in a longitudinal direction, and said cable drums are disposed successively in said longitudinal direction.

13. The container arrangement according to claim 12, wherein:
said at least one container has two end faces disposed opposite one other in said longitudinal direction and two side walls extending parallel to one another in said longitudinal direction, said side walls having sides connected to said end faces; and
one of said side walls has a side door or is a side door being dimensioned to simultaneously permit access to all of said cable drums and to permit all of said cable drums to be carried in and out of said at least one container through said side door.

14. The container arrangement according to claim 12, which further comprises a holding frame disposed in said at least one container, said holding frame being configured to receive a plurality of said cable drums disposed successively in said longitudinal direction.

15. The container arrangement according to claim 14, wherein a first and a second row of successively disposed cable drums are provided in said holding frame, and said second row is disposed above said first row.

16. The container arrangement according to claim 11, wherein said at least one container is a 20 ft container, a 40 ft container or a high-cube container.

17. The container arrangement according to claim 11, which further comprises a plurality of plug-in bushings disposed in said at least one container, said plurality of plug-in bushings being rated for different operating voltages.

18. The container arrangement according to claim 11, which further comprises a protection and control device disposed in said at least one container.

19. The container arrangement according to claim 11, which further comprises at least one transport trailer fitted with wheels, said at least one container being supported on said at least one transport trailer.

20. The container arrangement according to claim 15, wherein said holding frame has successively disposed holding frame portions not being connected to one another.
